(19) United States
(12) Patent Application Publication
(10) Pub. No.: US 2023/0102422 A1
(43) Pub. Date: Mar. 30, 2023

(54) IMAGE RECOGNITION METHOD AND APPARATUS, AND STORAGE MEDIUM

(71) Applicant: BEIJING BAIDU NETCOM SCIENCE TECHNOLOGY CO., LTD., Beijing (CN)

(72) Inventors: Desen ZHOU, Beijing (CN); Jian WANG, Beijing (CN); Hao SUN, Beijing (CN)

(73) Assignee: BEIJING BAIDU NETCOM SCIENCE TECHNOLOGY CO., LTD., Beijing (CN)

(21) Appl. No.: 17/807,375

(22) Filed: Jun. 16, 2022

(30) Foreign Application Priority Data
Sep. 27, 2021 (CN) 202111137718.1

(51) Int. Cl. G06V 40/20; G06V 20/70; G06V 40/10; G06V 10/82; G06V 10/74; G06V 10/42

(52) U.S. Cl. CPC G06V 40/20; G06V 20/70; G06V 40/10; G06V 10/82; G06V 10/74; G06V 10/42

(57) ABSTRACT

Provided is an image recognition method. The method includes determining subject decoded features of a to-be-detected image and an original interaction decoded feature of a subject interactive relationship in the to-be-detected image; determining subject decoded features associated with the original interaction decoded feature, and updating the original interaction decoded feature by using the associated subject decoded features so as to obtain a new interaction decoded feature; and according to the subject decoded features of the to-be-detected image and the new interaction decoded feature, determining at least two subjects to which the subject interactive relationship in the to-be-detected belongs.

### CROSS-REFERENCE TO RELATED APPLICATION

This application claims priority to Chinese Patent Application No. 202111137718.1 filed on Sep. 27, 2021, the disclosure of which is incorporated herein by reference in its entirety.

### TECHNICAL FIELD

The present disclosure relates to the field of artificial intelligence and, in particular, to the technology of computer vision and deep learning. The present disclosure may be for example applied to scenarios of smart cities and intelligent transportation and relates, in particular, to an image recognition method and apparatus, a device, a storage medium, and a program product.

### BACKGROUND

In the field of human action recognition, it is usually necessary to recognize a human body performing an action and an object corresponding to the action. This recognition process is referred to as the detection of a human-object interactive relationship. Specifically, the detection of a human-object interactive relationship refers to locating all human bodies and objects engaged in actions and their interactive relationships according to a given image.

In the case where the image includes a relatively large number of human bodies and objects and the actions are complex, how to detect a human-object interactive relationship is a challenge.

### SUMMARY

The present disclosure provides an image recognition method and apparatus, and a storage medium.

According to an aspect of the present disclosure, an image recognition method is provided. The method includes the steps below.

Subject decoded features of a to-be-detected image and an original interaction decoded feature of a subject interactive relationship in the to-be-detected image are determined.

Subject decoded features associated with the original interaction decoded feature are determined, and the original interaction decoded feature is updated by using the associated subject decoded features so as to obtain a new interaction decoded feature.

At least two subjects to which the subject interactive relationship in the to-be-detected image belongs are determined according to the subject decoded features of the to-be-detected image and the new interaction decoded feature.

According to another aspect of the present disclosure, an image recognition apparatus is provided. The apparatus includes at least one processor and a memory communicatively connected to the at least one processor.

The memory stores instructions executable by the at least one processor. The instructions are executed by the at least one processor to cause the at least one processor to perform steps in the following modules: a decoded feature determination module, an interaction decoded feature updating module, and an interactive subject determination module.

The decoded feature determination module is configured to determine subject decoded features of a to-be-detected image and an original interaction decoded feature of a subject interactive relationship in the to-be-detected image.

The interaction decoded feature updating module is configured to determine subject decoded features associated with the original interaction decoded feature and update the original interaction decoded feature by using the associated subject decoded features so as to obtain a new interaction decoded feature.

The interactive subject determination module is configured to determine, according to the subject decoded features of the to-be-detected image and the new interaction decoded feature, at least two subjects to which the subject interactive relationship in the to-be-detected image belongs.

According to another aspect of the present disclosure, a non-transitory computer-readable storage medium is provided. The storage medium stores computer instructions configured to cause a computer to perform the image recognition method according to any embodiment of the present disclosure.

Embodiments of the present disclosure can improve the accuracy of interactive relationship recognition.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a diagram of an image recognition method according to an embodiment of the present disclosure.

FIG. 2A is a diagram of an image recognition method according to an embodiment of the present disclosure.

FIG. 2B is a diagram illustrating the structure of an interaction decoder including N layers of decoding units and the structure of a subject decoder including N layers of decoding units according to an embodiment of the present disclosure.

FIG. 2C is a diagram illustrating the interaction between an interaction decoding unit and a subject decoding unit according to an embodiment of the present disclosure.

FIG. 3 is a diagram of an image recognition method according to an embodiment of the present disclosure.

FIG. 4 is a diagram of an image recognition apparatus according to an embodiment of the present disclosure.

FIG. 5 is a block diagram of an electronic device for performing an image recognition method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are merely illustrative. Therefore, it will be appreciated by those having ordinary skill in the art that various changes and modifications may be made to the embodiments described herein without departing from the scope and spirit of the present disclosure. Similarly, a description of well-known functions and constructions is omitted hereinafter for clarity and conciseness.

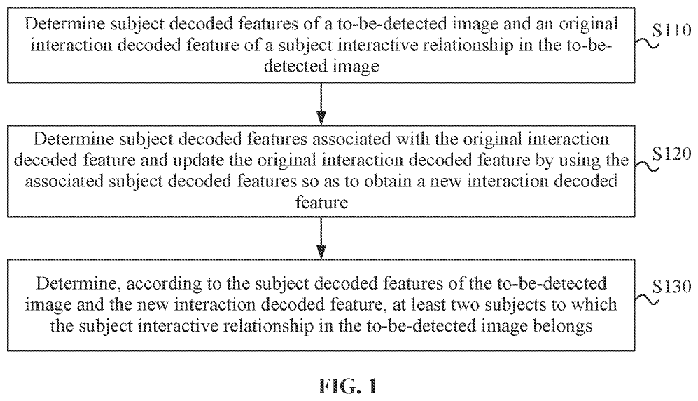

FIG. 1 is a diagram of an image recognition method according to an embodiment of the present disclosure. This embodiment can be applied to the case where an interaction decoded feature is updated through subject decoded features associated with the interaction decoded feature. The method of this embodiment can be performed by an image recognition apparatus. The apparatus may be implemented by software and/or hardware and is for example configured in an electronic device having a certain data computing capability. The electronic device may be a client device or a server device. The client device is, for example, a mobile phone, a tablet computer, an in-vehicle terminal, or a desktop computer.

In S110, subject decoded features of a to-be-detected image and an original interaction decoded feature of a subject interactive relationship in the to-be-detected image are determined.

The to-be-detected image includes at least two subjects and the subject interactive relationship. A subject in the to-be-detected image may be a human body or an object, and the subject interactive relationship may be an action performed by the human body. Exemplarily, the to-be-detected image includes a scenario of a person drinking water. Then the subjects included in the to-be-detected image are the person and a cup, and the subject interactive relationship is the action of drinking water.

The subject decoded features and the original interaction decoded feature are feature vectors obtained by decoding an image encoded feature. The image encoded feature is a feature vector obtained by encoding an image feature of the to-be-detected image. The image feature may be a feature vector obtained by extracting a feature of the to-be-detected image through a convolutional neural network. Exemplarily, the image encoded feature is decoded through a subject decoding unit to obtain the subject decoded features. Correspondingly, the image encoded feature is decoded through an interaction decoding unit to obtain the original interaction decoded feature.

In embodiments of the present disclosure, in order to detect the interactive relationship in the to-be-detected image, the subject decoded features of the to-be-detected image and the original interaction decoded feature of the subject interactive relationship in the to-be-detected image are determined. In an embodiment, the to-be-detected image is input into a convolutional neural network for feature extraction to obtain an image feature. The image feature is input into an image encoder for encoding to obtain an image encoded feature. Moreover, the image encoded feature is input into a subject decoding unit and an interaction decoding unit to obtain the subject decoded features output by the subject decoding unit and the interaction decoded feature output by the interaction decoding unit.

The image encoder is a Transformer encoder. The image encoder may include multiple layers of image encoding units. Each image encoding unit is composed of a self-attention layer and a feedforward neural network layer. The subject decoding unit is one layer of a subject decoder, that is, the subject decoder includes multiple layers of subject decoding units. Similarly, the interaction decoding unit is one layer of an interaction decoder, that is, the interaction decoder includes multiple layers of interaction decoding units. The subject decoder and the interaction decoder are each a Transformer decoder. Each subject decoding unit or each interaction decoding unit is composed of a self-attention layer, an encoder-decoder attention layer, and a feedforward neural network layer. Exemplarily, the image encoder includes six layers of image encoding units, the subject decoder includes six layers of subject decoding units, and the interaction decoder includes six layers of interaction decoding units.

In S120, subject decoded features associated with the original interaction decoded feature are determined, and the original interaction decoded feature is updated by using the associated subject decoded features so as to obtain a new interaction decoded feature.

The subject decoded features associated with the original interaction decoded feature can be understood as subject decoded features corresponding respectively to the human body and the object that are associated with the subject interactive relationship to which the original interaction decoded feature belongs. Exemplarily, for the interactive action whose subject interactive relationship is drinking water, the subjects associated with the subject interactive relationship are the person and the cup. Then the original interaction decoded feature is a decoded feature of the interactive action of drinking water. The subject decoded features associated with the original interaction decoded feature are a decoded feature corresponding to the human body and a decoded feature corresponding to the cup.

In embodiments of the present disclosure, after the subject decoded features of the subjects included in the to-be-detected image and the original interaction decoded feature of the subject interactive relationship included in the to-be-detected image are acquired, the original interaction decoded feature is matched with each subject decoded feature to obtain at least two subject decoded features associated with the original interaction decoded feature. In an embodiment, predicted subject semantic embeddings of the subjects associated with the original interaction decoded feature are predicted according to the original interaction decoded feature.

Moreover, each subject decoded feature is processed to obtain a real subject semantic embedding corresponding to each subject. The predicted subject semantic embeddings are matched with real subject semantic embeddings so as to determine the subject decoded features associated with the original interaction decoded feature.

Exemplarily, in order to match the original interaction decoded feature with the subject decoded features, each subject decoded feature is input into a multilayer perceptron to obtain the real subject semantic embedding of each subject. Similarly, the original interaction decoded feature is input into the multilayer perceptron to obtain predicted subject semantic embeddings of predicted subjects corresponding to each subject interactive relationship. The predicted subjects may include a predicted human body and a predicted object. Correspondingly, the subject semantic embeddings of the predicted subjects include a predicted human body semantic embedding and a predicted object semantic embedding. Moreover, the subject decoded features associated with the original interaction decoded feature are determined according to the relationship between the predicted human body semantic embedding, the predicted object semantic embedding, and the subject semantic embeddings. For example, a human body decoded feature is determined according to the Euclidean distance between the predicted human body semantic embedding and the subject semantic embedding, and an object decoded feature is determined according to the Euclidean distance between the predicted object semantic embedding and the subject semantic embedding.

In the case where a relatively large number of subjects and interactive relationships are included in a to-be-detected image and the scenario is complex, the recognition of an interactive relationship is error-prone. In embodiments of the present disclosure, the original interaction decoded feature is updated by using the subject decoded features associated with the original interaction decoded feature so that the accuracy of interactive relationship recognition in the image is improved. Exemplarily, after a human body decoded feature associated with the original interaction decoded feature and an object decoded feature associated with the original interaction decoded feature are spatially transformed, the transformed human body decoded feature and the transformed object decoded feature are superimposed onto the original interaction decoded feature to obtain the new interaction decoded feature, thereby improving the accuracy of interactive relationship recognition by using the subject decoded features to assist the original interaction decoded feature.

In S130, at least two subjects to which the subject interactive relationship in the to-be-detected image belongs are determined according to the subject decoded features of the to-be-detected image and the new interaction decoded feature.

In embodiments of the present disclosure, the at least two subjects to which the subject interactive relationship in the to-be-detected image belongs are determined according to the subject decoded features of the to-be-detected image and the new interaction decoded feature obtained by updating the original interaction decoded feature. In an embodiment, the new interaction decoded feature is matched with each subject decoded feature to obtain at least two subject decoded features matching the new interaction decoded feature; moreover, it is determined that subjects corresponding to the obtained subject decoded features are subjects to which the subject interactive relationship belongs corresponding to the new interaction decoded feature.

Exemplarily, the subject decoded features are input into the multilayer perceptron to obtain the subject semantic embeddings of the subject decoded features. Similarly, the new interaction decoded feature is input into the multilayer perceptron to predict a predicted human body semantic embedding corresponding to the new interaction decoded feature and a predicted object semantic embedding corresponding to the new interaction decoded feature. Moreover, the at least two subject decoded features associated with the new interaction decoded feature are determined according to the relationship between the predicted human body semantic embedding, the predicted object semantic embedding, and the subject semantic embeddings. Further, it is determined that the subjects corresponding to the obtained at least two subject decoded features are the subjects to which the current subject interactive relationship belongs.

In the technical solutions of embodiments of the present disclosure, the subject decoded features of the to-be-detected image and the original interaction decoded feature of the subject interactive relationship in the to-be-detected image are determined; further, the subject decoded features associated with the original interaction decoded feature are determined, and the original interaction decoded feature is updated by using the associated subject decoded features so as to obtain the new interaction decoded feature; and the at least two subjects to which the subject interactive relationship in the to-be-detected image belongs are determined according to the subject decoded features of the to-be-detected image and the new interaction decoded feature. The arrangement in which the original interaction decoded feature is updated by using the subject decoded features associated with the original interaction decoded feature improves the accuracy of interactive relationship recognition in the image.

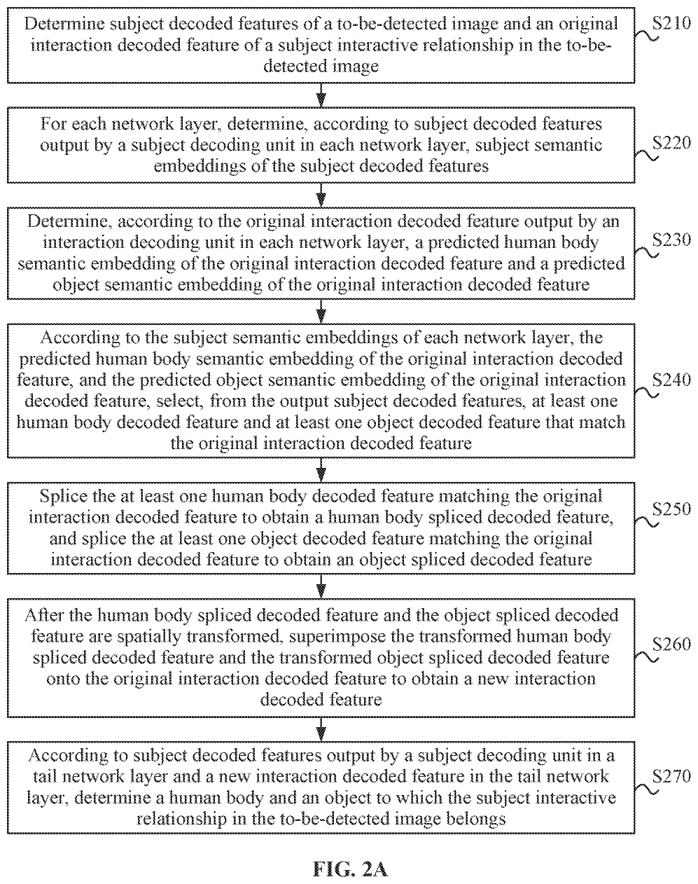

FIG. 2A is a diagram of an image recognition method according to an embodiment of the present disclosure, which is further refined based on the preceding embodiment. The step in which subject decoded features associated with an original interaction decoded feature are determined and in which the original interaction decoded feature is updated by using the associated subject decoded features so as to obtain a new interaction decoded feature is provided. Moreover, the step in which at least two subjects to which a subject interactive relationship in the to-be-detected image belongs are determined according to subject decoded features of the to-be-detected image and the new interaction decoded feature is provided. The image recognition method according to an embodiment of the present disclosure is described hereinafter in conjunction with FIG. 2A. The method includes the steps below.

In S210, subject decoded features of a to-be-detected image and an original interaction decoded feature of a subject interactive relationship in the to-be-detected image are determined.

In S220, for each network layer, subject semantic embeddings of the subject decoded features are determined according to subject decoded features output by a subject decoding unit in each network layer.

When an image encoded feature of the to-be-detected image is decoded, an interaction decoder and a subject decoder are needed. The structure of the interaction decoder including N layers of decoding units and the structure of the subject decoder including N layers of decoding units are shown in FIG. 2B. The interaction decoder includes multiple layers of interaction decoding units. The subject decoder includes multiple layers of subject decoding units. An interaction decoding unit and a subject decoding unit that are in the same level constitute one network layer.

In embodiments of the present disclosure, for each network layer, in order to match an original interaction decoded feature output by an interaction decoding unit with subject decoded features output by a subject decoding unit, it is necessary to transform the subject decoded features output by the subject decoding unit in each network layer to obtain the subject semantic embeddings of the subject decoded features. Exemplarily, in each network layer, the subject decoded features output by the subject decoding unit in each network layer are input into a multilayer perceptron to obtain the subject semantic embeddings of the subject decoded features so that the subject semantic embeddings are used for calculating subject decoded features matching the original interaction decoded feature in the subsequent process.

In S230, a predicted human body semantic embedding of the original interaction decoded feature and a predicted object semantic embedding of the original interaction decoded feature are determined according to the original interaction decoded feature output by the interaction decoding unit in each network layer.

In embodiments of the present disclosure, after subject semantic embeddings output in one network layer are obtained, according to an original interaction decoded feature output by an interaction decoding unit in the network layer, a predicted human body semantic embedding of the original interaction decoded feature and a predicted object semantic embedding of the original interaction decoded feature are further predicted. Exemplarily, the original interaction decoded feature output by the interaction decoding unit in the network layer is input into the multilayer perceptron to output the predicted human body semantic embedding corresponding to the original interaction decoded feature and the predicted object semantic embedding corresponding to the original interaction decoded feature. Accordingly, in the subsequence process, the predicted human body semantic embedding and the subject semantic embeddings are used for determining a human body decoded feature matching the current interaction decoded feature, and the predicted object semantic embedding and the subject semantic embeddings are used for determining an object decoded feature matching the current interaction decoded feature.

In S240, according to the subject semantic embeddings of each network layer, the predicted human body semantic embedding of the original interaction decoded feature, and the predicted object semantic embedding of the original interaction decoded feature, at least one human body decoded feature and at least one object decoded feature that match the original interaction decoded feature are selected from the output subject decoded features.

In embodiments of the present disclosure, after the subject semantic embeddings, the predicted human body semantic embedding, and the predicted object semantic embedding are acquired, the at least one human body decoded feature and the at least one object decoded feature that match the original interaction decoded feature are selected from the subject decoded features according to the subject semantic embeddings of each network layer, the predicted human body semantic embedding of the original interaction decoded feature, and the predicted object semantic embedding of the original interaction decoded feature. Exemplarily, a human body decoded feature matching the original interaction decoded feature may be determined by calculating the Euclidean distance between the predicted human body semantic embedding and each subject semantic embedding, and an object decoded feature matching the original interaction decoded feature may be determined by calculating the Euclidean distance between the predicted object semantic embedding and each subject semantic embedding. The predicted human body semantic embedding and the predicted object semantic embedding are matched with the subject semantic embeddings separately to obtain the at least one human body decoded feature and the at least one object decoded feature that match the original interaction decoded feature. Accordingly, the associated at least one human body decoded feature and the associated at least one object decoded feature are used for assisting in the update of the original interaction decoded feature in the subsequent process, improving the accuracy of the recognition of the subject interactive relationship.

Optionally, the step in which the at least one human body decoded feature and the at least one object decoded feature that match the original interaction decoded feature are selected from the subject decoded features according to the subject semantic embeddings of each network layer, the predicted human body semantic embedding of the original interaction decoded feature, and the predicted object semantic embedding of the original interaction decoded feature includes the steps below.

A first Euclidean distance between the predicted human body semantic embedding and each subject semantic embedding is calculated, and the at least one human body decoded feature matching the original interaction decoded feature is determined from the output subject decoded features according to the first Euclidean distance.

A second Euclidean distance between the predicted object semantic embedding and each subject semantic embedding is calculated, and the at least one object decoded feature matching the original interaction decoded feature is determined from the output subject decoded features according to the second Euclidean distance.

Embodiments of the present disclosure provide a manner for performing the step in which the at least one human body decoded feature and the at least one object decoded feature that match the original interaction decoded feature are selected from the subject decoded features according to the subject semantic embeddings of each network layer, the predicted human body semantic embedding of the original interaction decoded feature, and the predicted object semantic embedding of the original interaction decoded feature. The manner includes the following: The Euclidean distance between the predicted human body semantic embedding and each subject semantic embedding in each network layer is calculated, at least one subject semantic embedding is determined from the subject semantic embeddings according to the

Euclidean distance, and a subject decoded feature corresponding to a selected subject semantic embedding is determined as a human body decoded feature; similarly, the Euclidean distance between the predicted object semantic embedding and each subject semantic embedding in each network layer is calculated, at least one subject semantic embedding is determined from the subject semantic embeddings according to the Euclidean distance, and a subject decoded feature corresponding to a selected subject semantic embedding is determined as an object decoded feature. The manner of calculating the Euclidean distance helps with a rapid determination of a human body decoded feature corresponding to the original interaction decoded feature and an object decoded feature corresponding to the original interaction decoded feature, thereby improving calculation efficiency.

Exemplarily, the first Euclidean distance between the predicted human body semantic embedding vᵢ^{h} and each subject semantic embedding μⱼ is calculated. Moreover, a subject decoded feature

$${x}_{{c}_{i}^{h}}^{inst} \qquad c$$

corresponaing to me smallest rust Euclidean distance is determined as a human body decoded feature matching the original interaction decoded feature xᵢ^{inter}. The calculation formula of cᵢ^{h} is as below.

cᵢ^{h}=argminⱼ(|vᵢ^{h}−μⱼ|)

vᵢ^{h} denotes the predicted human body semantic embedding of the i^{th} original interaction decoded feature. μⱼ denotes the subject semantic embedding of the j^{th} subject decoded feature.

Correspondingly, the second Euclidean distance between the predicted object semantic embedding vᵢ^{o} and each subject semantic embedding μⱼ is calculated. Moreover, a subject decoded feature

$${x}_{{c}_{i}^{o}}^{inst}$$

corresponding to the smallest second Euclidean distance is determined as an object decoded feature matching the original interaction decoded feature xᵢ^{inter}. The calculation formula is as below.

cᵢ^{o}=argminⱼ(|ᵢ^{o}−μⱼ|)

vᵢ^{o} denotes the predicted object semantic embedding of the i^{th} original interaction decoded feature. μⱼ denotes the subject semantic embedding of the j^{th} subject decoded feature.

Optionally, the step in which the at least one human body decoded feature matching the original interaction decoded feature is determined from the subject decoded features according to the first Euclidean distance includes the step below.

The subject semantic embeddings are sorted according to the first Euclidean distance. A set number of subject semantic embeddings are selected according to the sorting result and the level of each network layer. Moreover, subject decoded features corresponding to the selected subject semantic embeddings are determined as human body decoded features matching the original interaction decoded feature.

The step in which the at least one object decoded feature matching the original interaction decoded feature is determined from the subject decoded features according to the second Euclidean distance includes the step below.

The subject semantic embeddings are sorted according to the second Euclidean distance. A set number of subject semantic embeddings are selected according to the sorting result and the level of each network layer. Moreover, subject decoded features corresponding to the selected subject semantic embeddings are determined as object decoded features matching the original interaction decoded feature.

A lower level of a network layer indicates a greater number of selected subject semantic embeddings.

When an original interaction decoded feature is updated through subject decoded features, it is necessary to match the subject decoded features with the original interaction decoded feature. On this basis, if the matching is not accurate, the effect of improving the accuracy of interactive relationship recognition by updating the original interaction decoded feature cannot be achieved. Accordingly, in this optional embodiment, when the subject decoded features are matched with the original interaction decoded feature, at least one human body decoded feature and at least one object decoded feature are selected to update the original interaction decoded feature, avoiding a meaningless update caused by inaccurate matching when a unique human body decoded feature and a unique object decoded feature are selected to update the original interaction decoded feature.

In an embodiment, a manner for performing the step in which the at least one human body decoded feature matching the original interaction decoded feature is determined from the subject decoded features according to the first Euclidean distance is provided as follows: First, the subject semantic embeddings are sorted according to the first Euclidean distance; further, a set number of subject semantic embeddings are selected according to the sorting result and the level of each network layer; moreover, subject decoded features corresponding to the selected subject semantic embeddings are determined as object decoded features matching the original interaction decoded feature. The number of selected subject semantic embeddings is determined by the level of a network layer. The lower the level of a network layer is, the greater the number of selected subject semantic embeddings is, that is, the lower level of a network layer is, the greater the number of human body decoded features that are determined is.

Exemplarily, the subject semantic embeddings are sorted according to first Euclidean distances in ascending order. Further, it is determined that a set number corresponding to the level of the current network layer is k, and k subject semantic embeddings are selected in sequence in the sorting result. the k subject decoded features corresponding to the k subject semantic embeddings are determined as human body decoded features that match the original interaction decoded feature and are used for updating the original interaction decoded feature. In an embodiment, the formula for calculating the k human body decoded features is as below.

(cᵢ^{h})₁, (cᵢ^{h})₂, . . . , (cᵢ^{h})ₖtopkminⱼ(|vᵢ^{h}−μⱼ|)

topkmin is used for representing the first k subject semantic embeddings closest to the predicted human body semantic embedding. vᵢ^{h} denotes the predicted human body semantic embedding of the i^{th} original interaction decoded feature. μⱼ denotes the subject semantic embedding of the j^{th} subject decoded feature.

Correspondingly, a manner for performing the step in which the at least one object decoded feature matching the original interaction decoded feature is determined from the subject decoded features according to the second Euclidean distance is provided as follows: First, the subject semantic embeddings are sorted according to the second Euclidean distance; further, a set number of subject semantic embeddings are selected according to the sorting result and the level of each network layer; moreover, subject decoded features corresponding to the selected subject semantic embeddings is determined as object decoded features matching the original interaction decoded feature. The number of selected subject semantic embeddings is determined by the level of a network layer. The lower the level of a network layer is, the greater the number of selected subject semantic embeddings becomes, that is, the lower level of a network layer is, the greater the number of object decoded features that are determined is.

Exemplarily, the subject semantic embeddings are sorted according to second Euclidean distances in ascending order. Further, it is acquired that a set number corresponding to the level of the current network layer is k, and k subject semantic embeddings are selected in sequence in the sorting result. the k subject decoded features corresponding to the k subject semantic embeddings are determined as object decoded features that match the original interaction decoded feature and are used for updating the original interaction decoded feature. In an embodiment, the formula for calculating the k object decoded features is as below.

(cᵢ^{o})₁, (cᵢ^{o})₂, . . . , (cᵢ^{o})=topkminⱼ(|vᵢ^{h}−μⱼ|)

topkmin is used for representing the first k subject semantic embeddings closest to the predicted object semantic embedding. vᵢ^{h} denotes the predicted human body semantic embedding of the i^{th} original interaction decoded feature. μⱼ denotes the subject semantic embedding of the j^{th} subject decoded feature.

When the level of a network layer is low and the matching is not accurate, coarse matching is performed by increasing the number of human body decoded features and the number of object decoded features. With the gradual increase in the level of a network layer, the accuracy of matching improves. In this case, the human body decoded features and object decoded features that are used for updating the original interaction decoded feature can be decreased so that fine matching is performed. Exemplarily, it is assumed that k values correspond to network layer 1, network layer 2, . . . , and network layer N are k₁, k₂, . . . , and k_{N} respectively. Then it is set that k₁≥k₂≥ . . . ≥k_{N}. According to the preceding coarse-to-fine matching, the original interaction decoded feature can be updated through human body decoded features and object decoded features whenever the level of a network layer is lower or higher, improving the accuracy of interactive relationship recognition in the image.

In S250, the at least one human body decoded feature matching the original interaction decoded feature is spliced to obtain a human body spliced decoded feature, and the at least one object decoded feature matching the original interaction decoded feature is spliced to obtain an object spliced decoded feature.

In embodiments of the present disclosure, the information interaction between the interaction decoding unit and the subject decoding unit that are at each level is shown in FIG. 2C. The original interaction decoded feature output by the interaction decoding unit needs to be updated according to each human body decoded feature associated with the original interaction decoded feature and each object decoded feature associated with the original interaction decoded feature. In order to use multiple human body decoded features and multiple object decoded features simultaneously to update the original interaction decoded feature, the human body decoded features matching the original interaction decoded feature are spliced first to obtain the human body spliced decoded feature

$$concat [ {x}_{{( {c}_{i}^{h} )}_{1}}^{inst} ; {x}_{{( {c}_{i}^{h} )}_{2}}^{inst} ; … ; {x}_{{( {c}_{i}^{h} )}_{k}}^{inst} ] .$$

Moreover, the at least one object decoded feature matching the original interaction decoded feature is spliced to obtain the object spliced decoded feature

$$concat [ {x}_{{( {c}_{i}^{o} )}_{1}}^{inst} ; {x}_{{( {c}_{i}^{o} )}_{2}}^{inst} ; … ; {x}_{{( {c}_{i}^{o} )}_{k}}^{inst} ] .$$

Accordingly, the original interaction decoded feature is updated according to the human body spliced decoded feature and the object spliced decoded feature.

In S260, after the human body spliced decoded feature and the object spliced decoded feature are spatially transformed, the transformed human body spliced decoded feature and the transformed object spliced decoded feature are superimposed onto the original interaction decoded feature to obtain a new interaction decoded feature.

In embodiments of the present disclosure, after being spatially transformed, the human body spliced decoded feature and the object spliced decoded feature are superimposed onto the original interaction decoded feature to implement the update of the original interaction decoded feature. In each network layer, the original interaction decoded feature output by the interaction decoding unit is updated so that the accuracy of the subject interactive relationship output by the interaction decoder in the last layer improves. The calculation formula of the new interaction decoded feature is specified as below.

$${x}_{i}^{′inter} = {x}_{i}^{inter} + {W}_{h} concat [ {x}_{{( {c}_{i}^{h} )}_{1}}^{inst} ; {x}_{{( {c}_{i}^{h} )}_{2}}^{inst} ; … ; {x}_{{( {c}_{i}^{h} )}_{k}}^{inst} ] + {W}_{o} concat [ {x}_{{( {c}_{i}^{o} )}_{1}}^{inst} ; {x}_{{( {c}_{i}^{o} )}_{2}}^{inst} ; … ; {x}_{{( {c}_{i}^{o} )}_{k}}^{inst} ]$$

xᵢ^{,inter} denotes the new interaction decoded feature. xᵢ^{inter} denotes the original interaction decoded feature. Wₕ is a transformation factor of the human body spliced decoded feature. Wₒ is a transformation factor of the object spliced decoded feature.

In S270, a human body and an object to which the subject interactive relationship in the to-be-detected image belongs are determined according to subject decoded features output by a subject decoding unit in a tail network layer and a new interaction decoded feature.

In embodiments of the present disclosure, after an original interaction decoded feature output by an interaction decoding unit in the tail network layer is updated to obtain the new interaction decoded feature, the subject decoded features output by the subject decoding unit in the tail network layer are further matched with the new interaction decoded feature to obtain the human body and the object to which the subject interactive relationship in the to-be-detected image belongs. The arrangement in which the new interaction decoded feature is matched with the subject decoded features helps improve the accuracy of acquiring the human body and the object to which the subject interactive relationship belongs.

In an embodiment, the new interaction decoded feature is input into the multilayer perceptron to predict a predicted human body semantic embedding corresponding to the new interaction decoded feature and a predicted object semantic embedding corresponding to the new interaction decoded feature. Moreover, the subject decoded features are input into the multilayer perceptron to obtain the subject semantic embeddings of the subject decoded features. Through calculating the Euclidean distance between the predicted human body semantic embedding and each subject semantic embedding, a subject decoded feature corresponding to a subject semantic embedding with the smallest Euclidean distance is determined as a human body decoded feature corresponding to the interaction decoded feature. A human body corresponding to the human body decoded feature is a human body to which the subject interactive relationship belongs. Similarly, through calculating the Euclidean distance between the predicted object semantic embedding and each subject semantic embedding, a subject decoded feature corresponding to a subject semantic embedding with the smallest Euclidean distance is determined as an object decoded feature corresponding to the interaction decoded feature. An object corresponding to the object decoded feature is an object to which the subject interactive relationship belongs.

According to the technical solutions of the present disclosure, the arrangement in which the original interaction decoded feature is updated through each human body decoded feature associated with the original interaction decoded feature and each object decoded feature associated with the original interaction decoded feature can improve the accuracy of interactive relationship recognition in the image. Moreover, the number of human body decoded features for updating the original interaction decoded feature and the number of object decoded features for updating the original interaction decoded feature are determined according to the level of a network layer. Accordingly, coarse matching is performed when the level of a network layer is relatively low, and fine matching is performed when the level of a network layer is relatively high, avoiding a meaningless update caused by inaccurate matching when a unique human body decoded feature and a unique object decoded feature are selected to update the original interaction decoded feature, and thus further improving the accuracy of interactive relationship recognition in the image.

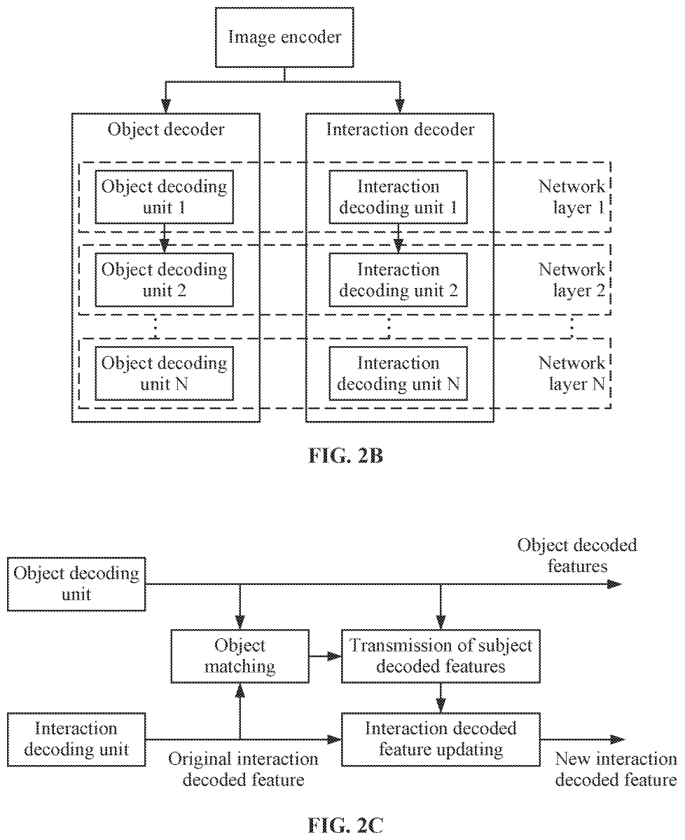

FIG. 3 is a diagram of an image recognition method according to an embodiment of the present disclosure, which is further refined based on the preceding embodiments and provides steps before subject decoded features of a to-be-detected image and an original interaction decoded feature of a subject interactive relationship in the to-be-detected image are determined. The image recognition method according to an embodiment of the present disclosure is described hereinafter in conjunction with FIG. 3. The method includes the steps below.

In S310, a to-be-detected image is input into a backbone residual network for image feature extraction to obtain an image feature of the to-be-detected image.

In embodiments of the present disclosure, in the detection of an interactive relationship included in the to-be-detected image, feature extraction is performed first for the to-be-detected image. In an embodiment, the to-be-detected image is input into the backbone residual network for image feature extraction to obtain the image feature of the to-be-detected image. Exemplarily, the backbone residual network may be ResNet50 or ResNet101. The use of the backbone residual network can alleviate the vanishing gradient problem and improve the effect of image feature extraction when the network depth needs to be increased.

In S320, the image feature of the to-be-detected image is input into an image encoder to obtain an image encoded feature output by the image encoder. The image encoded feature is used for determining subject decoded features of a head network layer and an interaction decoded feature of the head network layer.

In embodiments of the present disclosure, after the image feature is obtained, the image feature is input into the image encoder and is encoded by multiple layers of image encoding units included in the image encoder so that the image encoded feature output by an image encoding unit in the last layer is obtained. The image encoded feature is used for being input into the head network layer of a decoder and being decoded by a subject decoding unit and an interaction decoding unit that are in the head network layer to obtain the subject decoded features and the interaction decoded feature. The input of a subject decoding unit in any network layer except the head network layer is subject decoded features output by a subject decoding unit in the adjacent previous network layer. The input of an interaction decoding unit in any network layer except the head network layer is a new interaction decoded feature updated by subject decoded features output by a subject decoding unit in the adjacent previous network layer.

In S330, subject decoded features of the to-be-detected image and an original interaction decoded feature of a subject interactive relationship in the to-be-detected image are determined.

In S340, subject decoded features associated with the original interaction decoded feature are determined, and the original interaction decoded feature is updated by using the associated subject decoded features so as to obtain a new interaction decoded feature.

In S350, at least two subjects to which the subject interactive relationship in the to-be-detected image belongs are determined according to the subject decoded features of the to-be-detected image and the new interaction decoded feature.

According to the technical solutions of the present disclosure, the to-be-detected image is input into the backbone residual network for image feature extraction to obtain the image feature of the to-be-detected image; then the image feature of the to-be-detected image is input into the image encoder to obtain the image encoded feature output by the image encoder; further, the subject decoded features of the to-be-detected image and the original interaction decoded feature of the subject interactive relationship in the to-be-detected image are determined; the subject decoded features associated with the original interaction decoded feature are determined, and the original interaction decoded feature is updated by using the associated subject decoded features so as to obtain the new interaction decoded feature; and according to the subject decoded features of the to-be-detected image and the new interaction decoded feature, the at least two subjects to which the subject interactive relationship in the to-be-detected image belongs are determined. The update of the original interaction decoded feature can improve the accuracy of interactive relationship recognition in the image.

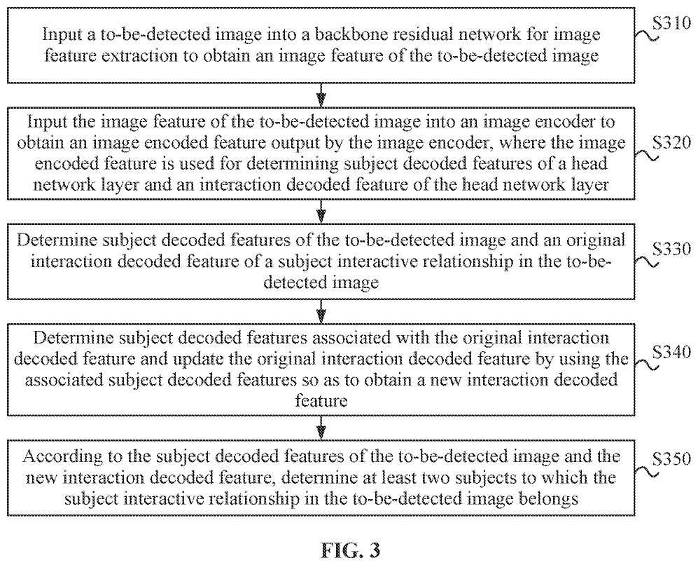

According to embodiments of the present application, FIG. 4 is a diagram illustrating the structure of an image recognition apparatus according to an embodiment of the present disclosure. Embodiments of the present disclosure are applied to the case where an interaction decoded feature is updated through subject decoded features associated with the interaction decoded feature. The apparatus is implemented by software and/or hardware and is configured in an electronic device having a certain data computing capability.

The image recognition apparatus 400 as shown in FIG. 4 includes a decoded feature determination module 410, an interaction decoded feature updating module 420, and an interactive subject determination module 430.

The decoded feature determination module 410 is configured to determine subject decoded features of a to-be-detected image and an original interaction decoded feature of a subject interactive relationship in the to-be-detected image.

The interaction decoded feature updating module 420 is configured to determine subject decoded features associated with the original interaction decoded feature and update the original interaction decoded feature by using the associated subject decoded features so as to obtain a new interaction decoded feature.

The interactive subject determination module 430 is configured to determine, according to the subject decoded features of the to-be-detected image and the new interaction decoded feature, at least two subjects to which the subject interactive relationship in the to-be-detected image belongs.

In the technical solutions of embodiments of the present disclosure, the subject decoded features of the to-be-detected image and the original interaction decoded feature of the subject interactive relationship in the to-be-detected image are determined; further, the subject decoded features associated with the original interaction decoded feature are determined, and the original interaction decoded feature is updated by using the associated subject decoded features so as to obtain the new interaction decoded feature; and, according to the subject decoded features of the to-be-detected image and the new interaction decoded feature, the at least two subjects to which the subject interactive relationship in the to-be-detected image belongs are determined. The arrangement in which the original interaction decoded feature is updated by using the subject decoded features associated with the original interaction decoded feature improves the accuracy of interactive relationship recognition in the image.

Optionally, the interaction decoded feature updating module includes a subject semantic embedding determination unit, a predicted semantic embedding determination unit, and a human-object decoded feature determination unit.

The subject semantic embedding determination unit is configured to, for each network layer, according to subject decoded features output by a subject decoding unit in each network layer, determine subject semantic embeddings of the subject decoded features.

The predicted semantic embedding determination unit is configured to, according to an original interaction decoded feature output by an interaction decoding unit in each network layer, determine a predicted human body semantic embedding of the original interaction decoded feature and a predicted object semantic embedding of the original interaction decoded feature.

The human-object decoded feature determination unit is configured to, according to the subject semantic embeddings of each network layer, the predicted human body semantic embedding of the original interaction decoded feature, and the predicted object semantic embedding of the original interaction decoded feature, select, from the output subject decoded features, at least one human body decoded feature and at least one object decoded feature that match the original interaction decoded feature.

Optionally, the human-object decoded feature determination unit includes a human body decoded feature determination sub-unit and an object decoded feature determination sub-unit.

The human body decoded feature determination sub-unit is configured to calculate a first Euclidean distance between the predicted human body semantic embedding and each subject semantic embedding and according to the first Euclidean distance, determine, from the subject decoded features, the at least one human body decoded feature matching the original interaction decoded feature.

The object decoded feature determination sub-unit is configured to calculate a second Euclidean distance between the predicted object semantic embedding and each subject semantic embedding and according to the second Euclidean distance, determine, from the subject decoded features, the at least one object decoded feature matching the original interaction decoded feature.

Optionally, the interaction decoded feature updating module includes a spliced decoded feature acquisition unit and an interaction decoded feature updating unit.

The spliced decoded feature acquisition unit is configured to splice the at least one human body decoded feature matching the original interaction decoded feature to obtain a human body spliced decoded feature and splice the at least one object decoded feature matching the original interaction decoded feature to obtain an object spliced decoded feature.

The interaction decoded feature updating unit is configured to superimpose the transformed human body spliced decoded feature and the transformed object spliced decoded feature onto the original interaction decoded feature to obtain the new interaction decoded feature after spatially transforming the human body spliced decoded feature and the object spliced decoded feature.

Optionally, the human body decoded feature determination sub-unit may be configured to sort the subject semantic embeddings according to the first Euclidean distance, select a set number of subject semantic embeddings according to the sorting result and the level of each network layer, and determine subject decoded features corresponding to the selected subject semantic embeddings as human body decoded features matching the original interaction decoded feature.

The object decoded feature determination sub-unit is configured to sort the subject semantic embeddings according to the second Euclidean distance, select a set number of subject semantic embeddings according to the sorting result and the level of each network layer, and determine subject decoded features corresponding to the selected subject semantic embeddings as object decoded features matching the original interaction decoded feature.

A lower level of a network layer indicates a greater number of selected subject semantic embeddings.

Optionally, the interactive subject determination module is configured to, according to subject decoded features output by a subject decoding unit in a tail network layer and a new interaction decoded feature in the tail network layer, determine a human body and an object to which the subject interactive relationship in the to-be-detected image belongs.

Optionally, the image recognition apparatus further includes an image feature acquisition module and an encoded feature acquisition module.

The image feature acquisition module is configured to input the to-be-detected image into a backbone residual network for image feature extraction to obtain an image feature of the to-be-detected image.

The encoded feature acquisition module is configured to input the image feature of the to-be-detected image into an image encoder to obtain an image encoded feature output by the image encoder. The image encoded feature is used for determining subject decoded features of a head network layer and an interaction decoded feature of the head network layer.

The image recognition apparatus according to embodiments of the present disclosure can execute an image recognition method according to any embodiment of the present disclosure and has functional modules and effects corresponding to the execution method.

In the technical solutions of the present disclosure, the collection, storage, use, processing, transmission, provision, and disclosure of user personal information involved are in compliance with provisions of relevant laws and regulations and do not violate public order and good customs.

According to embodiments of the present disclosure, the present disclosure further provides an electronic device, a readable storage medium, and a computer program product.

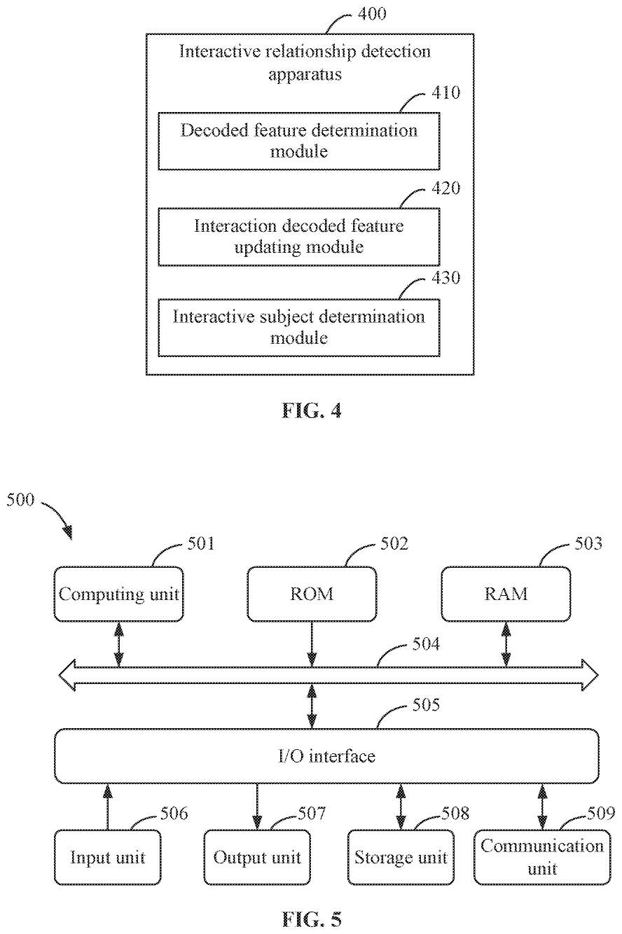

FIG. 5 is a block diagram of an electronic device for performing an image recognition method according to an embodiment of the present disclosure. The electronic device is intended to represent various forms of digital computers, for example, a laptop computer, a desktop computer, a worktable, a personal digital assistant, a server, a blade server, a mainframe computer, or another applicable computer. Electronic devices may further represent various forms of mobile apparatuses, for example, personal digital assistants, cellphones, smartphones, wearable devices, and other similar computing apparatuses. Herein the shown components, the connections and relationships between these components, and the functions of these components are illustrative only and are not intended to limit the implementation of the present disclosure as described and/or claimed herein.

As shown in FIG. 5, the device 500 includes a computing unit 501. The computing unit 502 may perform various types of appropriate operations and processing based on a computer program stored in a read-only memory (ROM) 502 or a computer program loaded from a storage unit 508 to a random-access memory (RAM) 503. Various programs and data required for operations of the device 500 may also be stored in the RAM 500. The computing unit 501, the ROM 502, and the RAM 503 are connected to each other through a bus 504. An input/output (I/O) interface 505 is also connected to the bus 504.

Multiple components in the device 500 are connected to the I/O interface 505. The multiple components include an input unit 506 such as a keyboard and a mouse, an output unit 507 such as various types of displays and speakers, the storage unit 508 such as a magnetic disk and an optical disk, and a communication unit 509 such as a network card, a modem and a wireless communication transceiver. The communication unit 509 allows the device 500 to exchange information/data with other devices over a computer network such as the Internet and/or over various telecommunication networks.

The computing unit 501 may be a general-purpose and/or special-purpose processing component having processing and computing capabilities. Examples of the computing unit 501 include, but are not limited to, a central processing unit (CPU), a graphics processing unit

(GPU), a special-purpose artificial intelligence (AI) computing chip, a computing unit executing machine learning model algorithms, a digital signal processor (DSP), and any appropriate processor, controller and microcontroller. The computing unit 501 performs various preceding methods and processing, such as the image recognition method. For example, in some embodiments, the image recognition method may be implemented as computer software programs tangibly contained in a machine-readable medium such as the storage unit 508. In some embodiments, part or all of computer programs may be loaded and/or installed on the device 500 via the ROM 502 and/or the communication unit 509. When the computer program is loaded to the RAM 503 and executed by the computing unit 501, one or more steps of the preceding image recognition method may be performed. Alternatively, in other embodiments, the computing unit 501 may be configured, in any other suitable manner (for example, by means of firmware), to perform the image recognition method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a dedicated or general-purpose programmable processor for receiving data and instructions from a memory system, at least one input device and at least one output device and transmitting the data and instructions to the memory system, the at least one input device and the at least one output device.

Program codes for the implementation of the method of the present disclosure may be written in any combination of one or more programming languages. These program codes may be provided for the processor or controller of a general-purpose computer, a special-purpose computer or another programmable data processing device to enable functions/operations specified in a flowchart and/or a block diagram to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory

(CD-ROM), an optical storage device, a magnetic storage device, or any appropriate combination thereof.

In order that interaction with a user is provided, the systems and techniques described herein may be implemented on a computer. The computer has a display device for displaying information to the user, such as a cathode-ray tube (CRT) or a liquid-crystal display (LCD) monitor, and a keyboard and a pointing device such as a mouse or a trackball through which the user can provide input for the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), and the Internet.

A computing system may include a client and a server. The client and the server are usually far away from each other and generally interact through the communication network.

The relationship between the client and the server arises by virtue of computer programs running on respective computers and having a client-server relationship to each other. The server may be a cloud server, a server of a distributed system, or a server combined with a blockchain.

It is to be understood that various forms of the preceding flows may be used with steps reordered, added, or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. An image recognition method, comprising:
determining subject decoded features of a to-be-detected image and an original interaction decoded feature of a subject interactive relationship in the to-be-detected image;
determining subject decoded features associated with the original interaction decoded feature; and updating the original interaction decoded feature by using the associated subject decoded features so as to obtain a new interaction decoded feature; and
determining, according to the subject decoded features of the to-be-detected image and the new interaction decoded feature, at least two subjects to which the subject interactive relationship in the to-be-detected image belongs.

2. The method according to claim 1, wherein determining the subject decoded features associated with the original interaction decoded feature comprises:
for each network layer, determining, according to subject decoded features output by a subject decoding unit in the each network layer, subject semantic embeddings of the subject decoded features;
determining a predicted human body semantic embedding of the original interaction decoded feature and a predicted object semantic embedding of the original interaction decoded feature according to an original interaction decoded feature output by an interaction decoding unit in the each network layer; and
selecting, from the output subject decoded features, at least one human body decoded feature and at least one object decoded feature that match the original interaction decoded feature according to the subject semantic embeddings of the each network layer, the predicted human body semantic embedding of the original interaction decoded feature, and the predicted object semantic embedding of the original interaction decoded feature.

3. The method according to claim 2, wherein according to the subject semantic embeddings of the each network layer, the predicted human body semantic embedding of the original interaction decoded feature, and the predicted object semantic embedding of the original interaction decoded feature, selecting, from the output subject decoded features, the at least one human body decoded feature and the at least one object decoded feature that match the original interaction decoded feature comprises:
calculating a first Euclidean distance between the predicted human body semantic embedding and each subject semantic embedding among the subject semantic embeddings; and determining, from the output subject decoded features, the at least one human body decoded feature matching the original interaction decoded feature according to the first Euclidean distance; and
calculating a second Euclidean distance between the predicted object semantic embedding and the each subject semantic embedding; and determining, from the output subject decoded features, the at least one object decoded feature matching the original interaction decoded feature according to the second Euclidean distance.

4. The method according to claim 2, wherein updating the original interaction decoded feature by using the associated subject decoded features so as to obtain the new interaction decoded feature comprises:
splicing the at least one human body decoded feature matching the original interaction decoded feature to obtain a human body spliced decoded feature, and splicing the at least one object decoded feature matching the original interaction decoded feature to obtain an object spliced decoded feature; and
after spatially transforming the human body spliced decoded feature and the object spliced decoded feature, superimposing the transformed human body spliced decoded feature and the transformed object spliced decoded feature onto the original interaction decoded feature to obtain the new interaction decoded feature.

5. The method according to claim 3, wherein determining, from the output subject decoded features, the at least one human body decoded feature matching the original interaction decoded feature according to the first Euclidean distance comprises:
sorting the subject semantic embeddings according to the first Euclidean distance, selecting a set number of subject semantic embeddings among the subject semantic embeddings according to a sorting result and a level of the each network layer, and determining subject decoded features corresponding to the selected subject semantic embeddings as human body decoded features matching the original interaction decoded feature; and
wherein determining, from the output subject decoded features, the at least one object decoded feature matching the original interaction decoded feature according to the second Euclidean distance comprises:
sorting the subject semantic embeddings according to the second Euclidean distance, selecting a set number of subject semantic embeddings among the subject semantic embeddings according to a sorting result and a level of the each network layer, and determining subject decoded features corresponding to the selected subject semantic embeddings as object decoded features matching the original interaction decoded feature;
wherein a lower level of a network layer indicates a greater number of selected subject semantic embeddings.

6. The method according to claim 2, wherein determining the at least two subjects to which the subject interactive relationship in the to-be-detected image belongs according to the subject decoded features of the to-be-detected image and the new interaction decoded feature comprises:
determining a human body and an object to which the subject interactive relationship in the to-be-detected image belongs according to subject decoded features output by a subject decoding unit in a tail network layer and a new interaction decoded feature.

7. The method according to claim 1, before determining the subject decoded features of the to-be-detected image and the original interaction decoded feature of the subject interactive relationship in the to-be-detected image, further comprising:
inputting the to-be-detected image into a backbone residual network for image feature extraction to obtain an image feature of the to-be-detected image; and
inputting the image feature of the to-be-detected image into an image encoder to obtain an image encoded feature output by the image encoder, wherein the image encoded feature is used for determining subject decoded features of a head network layer and an interaction decoded feature of the head network layer.

8. An image recognition apparatus, comprising:
at least one processor; and
a memory communicatively connected to the at least one processor;
wherein the memory stores instructions executable by the at least one processor to cause the at least one processor to perform steps in the following modules:a decoded feature determination module configured to determine subject decoded features of a to-be-detected image and an original interaction decoded feature of a subject interactive relationship in the to-be-detected image;
an interaction decoded feature updating module configured to determine subject decoded features associated with the original interaction decoded feature and update the original interaction decoded feature by using the associated subject decoded features so as to obtain a new interaction decoded feature; and
an interactive subject determination module is configured to determine, according to the subject decoded features of the to-be-detected image and the new interaction decoded feature, at least two subjects to which the subject interactive relationship in the to-be-detected image belongs.

9. The apparatus according to claim 8, wherein the interaction decoded feature updating module comprises:
a subject semantic embedding determination unit configured to, for each network layer, determine, according to subject decoded features output by a subject decoding unit in the each network layer, subject semantic embeddings of the subject decoded features;
a predicted semantic embedding determination unit configured to determine a predicted human body semantic embedding of the original interaction decoded feature and a predicted object semantic embedding of the original interaction decoded feature according to an original interaction decoded feature output by an interaction decoding unit in the each network layer; and
a human-object decoded feature determination unit configured to, according to the subject semantic embeddings of the each network layer, the predicted human body semantic embedding of the original interaction decoded feature, and the predicted object semantic embedding of the original interaction decoded feature, select, from the output subject decoded features, at least one human body decoded feature and at least one object decoded feature that match the original interaction decoded feature.

10. The apparatus according to claim 9, wherein the human-object decoded feature determination unit comprises:
a human body decoded feature determination sub-unit configured to calculate a first Euclidean distance between the predicted human body semantic embedding and each subject semantic embedding among the subject semantic embeddings and determine, from the subject decoded features, the at least one human body decoded feature matching the original interaction decoded feature according to the first Euclidean distance; and
an object decoded feature determination sub-unit configured to calculate a second Euclidean distance between the predicted object semantic embedding and the each subject semantic embedding and determine, from the subject decoded features, the at least one object decoded feature matching the original interaction decoded feature according to the second Euclidean distance.

11. The apparatus according to claim 9, wherein the interaction decoded feature updating module comprises:
a spliced decoded feature acquisition unit configured to splice the at least one human body decoded feature matching the original interaction decoded feature to obtain a human body spliced decoded feature and splice the at least one object decoded feature matching the original interaction decoded feature to obtain an object spliced decoded feature; and
an interaction decoded feature updating unit configured to superimpose the transformed human body spliced decoded feature and the transformed object spliced decoded feature onto the original interaction decoded feature to obtain the new interaction decoded feature after spatially transforming the human body spliced decoded feature and the object spliced decoded feature.

12. The apparatus according to claim 10, wherein the human body decoded feature determination sub-unit is configured to:
sort the subject semantic embeddings according to the first Euclidean distance, select a set number of subject semantic embeddings among the subject semantic embeddings according to a sorting result and a level of the each network layer, and determine subject decoded features corresponding to the selected subject semantic embeddings as human body decoded features matching the original interaction decoded feature; and
the object decoded feature determination sub-unit is configured to:
sort the subject semantic embeddings according to the second Euclidean distance, select a set number of subject semantic embeddings among the subject semantic embeddings according to a sorting result and a level of the each network layer, and determine subject decoded features corresponding to the selected subject semantic embeddings as object decoded features matching the original interaction decoded feature;
wherein a lower level of a network layer indicates a greater number of selected subject semantic embeddings.

13. The apparatus according to claim 9, wherein the interactive subject determination module is configured to:
determine a human body and an object to which the subject interactive relationship in the to-be-detected image belongs according to subject decoded features output by a subject decoding unit in a tail network layer and a new interaction decoded feature in the tail network layer.

14. The apparatus according to claim 8, further comprising:
an image feature acquisition module configured to input the to-be-detected image into a backbone residual network for image feature extraction to obtain an image feature of the to-be-detected image; and
an encoded feature acquisition module configured to input the image feature of the to-be-detected image into an image encoder to obtain an image encoded feature output by the image encoder, wherein the image encoded feature is used for determining subject decoded features of a head network layer and an interaction decoded feature of the head network layer.

15. A non-transitory computer-readable storage medium storing computer instructions configured to cause a computer to perform the following steps:
determining subject decoded features of a to-be-detected image and an original interaction decoded feature of a subject interactive relationship in the to-be-detected image;
determining subject decoded features associated with the original interaction decoded feature;
and updating the original interaction decoded feature by using the associated subject decoded features so as to obtain a new interaction decoded feature; and
determining, according to the subject decoded features of the to-be-detected image and the new interaction decoded feature, at least two subjects to which the subject interactive relationship in the to-be-detected image belongs.

16. The storage medium according to claim 15, wherein determining the subject decoded features associated with the original interaction decoded feature comprises:
for each network layer, determining, according to subject decoded features output by a subject decoding unit in the each network layer, subject semantic embeddings of the subject decoded features;
determining a predicted human body semantic embedding of the original interaction decoded feature and a predicted object semantic embedding of the original interaction decoded feature according to an original interaction decoded feature output by an interaction decoding unit in the each network layer; and
selecting, from the output subject decoded features, at least one human body decoded feature and at least one object decoded feature that match the original interaction decoded feature according to the subject semantic embeddings of the each network layer, the predicted human body semantic embedding of the original interaction decoded feature, and the predicted object semantic embedding of the original interaction decoded feature.

17. The storage medium according to claim 16, wherein according to the subject semantic embeddings of the each network layer, the predicted human body semantic embedding of the original interaction decoded feature, and the predicted object semantic embedding of the original interaction decoded feature, selecting, from the output subject decoded features, the at least one human body decoded feature and the at least one object decoded feature that match the original interaction decoded feature comprises:
calculating a first Euclidean distance between the predicted human body semantic embedding and each subject semantic embedding among the subject semantic embeddings; and determining, from the output subject decoded features, the at least one human body decoded feature matching the original interaction decoded feature according to the first Euclidean distance; and
calculating a second Euclidean distance between the predicted object semantic embedding and the each subject semantic embedding; and determining, from the output subject decoded features, the at least one object decoded feature matching the original interaction decoded feature according to the second Euclidean distance.

18. The storage medium according to claim 16, wherein updating the original interaction decoded feature by using the associated subject decoded features so as to obtain the new interaction decoded feature comprises:
splicing the at least one human body decoded feature matching the original interaction decoded feature to obtain a human body spliced decoded feature, and splicing the at least one object decoded feature matching the original interaction decoded feature to obtain an object spliced decoded feature; and
after spatially transforming the human body spliced decoded feature and the object spliced decoded feature, superimposing the transformed human body spliced decoded feature and the transformed object spliced decoded feature onto the original interaction decoded feature to obtain the new interaction decoded feature.

19. The storage medium according to claim 17, wherein determining, from the output subject decoded features, the at least one human body decoded feature matching the original interaction decoded feature according to the first Euclidean distance comprises:
sorting the subject semantic embeddings according to the first Euclidean distance, selecting a set number of subject semantic embeddings among the subject semantic embeddings according to a sorting result and a level of the each network layer, and determining subject decoded features corresponding to the selected subject semantic embeddings as human body decoded features matching the original interaction decoded feature; and
wherein determining, from the output subject decoded features, the at least one object decoded feature matching the original interaction decoded feature according to the second Euclidean distance comprises:
sorting the subject semantic embeddings according to the second Euclidean distance, selecting a set number of subject semantic embeddings among the subject semantic embeddings according to a sorting result and a level of the each network layer, and determining subject decoded features corresponding to the selected subject semantic embeddings as object decoded features matching the original interaction decoded feature;
wherein a lower level of a network layer indicates a greater number of selected subject semantic embeddings.

20. The storage medium according to claim 16, wherein determining the at least two subjects to which the subject interactive relationship in the to-be-detected image belongs according to the subject decoded features of the to-be-detected image and the new interaction decoded feature comprises:
determining a human body and an object to which the subject interactive relationship in the to-be-detected image belongs according to subject decoded features output by a subject decoding unit in a tail network layer and a new interaction decoded feature.
